(19) United States
(12) Patent Application Publication
(10) Pub. No.: US 2025/0197623 A1
(43) Pub. Date: Jun. 19, 2025

(54) WATER-BASED ADHESIVE COMPOSITION AND RELATED METHODS

(71) Applicant: 3M INNOVATIVE PROPERTIES COMPANY, St. Paul, MN (US)

(72) Inventors: Dillon S. Gentekos, St. Paul, MN (US); Michael D. Zenner, Hudson, WI (US); Lili Qie, Woodbury, MN (US); Babloo Sharma, St. Paul, MN (US)

(21) Appl. No.: 18/849,020

(22) PCT Filed: Mar. 20, 2023
(86) PCT No.: PCT/US2023/015622

§ 371 Date: Sep. 20, 2024

Related U.S. Application Data
(60) Provisional application No. 63/323,191, filed on Mar. 24, 2022.

(51) Int. Cl. C08L 33/08; B05C 19/04; B05D 1/14; C08J 3/07; C08L 9/06; C09J 5/00; C09J 9/00; C09J 109/06; C09J 133/08

(52) U.S. Cl. CPC C08L 33/08; B05C 19/04; B05D 1/14; C08J 3/07; C08L 9/06; C09J 5/00; C09J 9/00; C09J 109/06; C09J 133/08; B05D 2401/20; B05D 2502/00; B05D 2530/00

(57) ABSTRACT

A composition includes water, a polymeric adhesive dispersed in the composition, and a water-soluble polymer dissolved in the composition. The water-soluble polymer has a weight average molecular weight of at least 90,000 grams per mole. Typically, and advantageously, upon spraying the composition, the composition provides filaments including the polymeric adhesive and the water-soluble polymer. A process for making the composition, a method of using the composition, and a method for making a bonded article using the composition are also described.

### CROSS-REFERENCE TO RELATED APPLICATION

This application claims priority to U.S. Provisional Application No. 63/323,191, filed Mar. 24, 2022, the disclosure of which is incorporated by reference in its entirety herein.

### BACKGROUND

Pressure-sensitive adhesives (often referred to as PSAs) are useful for a variety of purposes. Applying PSAs may involve applying an adhesive polymer composition in organic solvent or as an oil-in-water emulsion onto a substrate and subsequently removing the solvent or water. Water-based adhesives have significant advantages over their traditional solvent borne counterparts in that they can have low or no volatile organic compounds and can be nonflammable.

Some references that disclose water-based adhesives and/or water-soluble polymers are disclosed in International Pat. Appl. Pub. No. WO 2020/169661, published Aug. 27, 2020; U.S. Pat. No. 7,851,522 (Hardy et al.), U.S. Pat. No. 7,067,189 (Huynh-Tran et al.), and U.S. Pat. No. 6,168,781 (Ukaji et al.); and U.S. Pat. Appl. Pub. No. 2021/0071049 (Gouveia et al.). A filament-forming aerosol for artificial hair or capturing insects is disclosed in Japanese Pat. Appl. No. 2008/231652, published Oct. 2, 2008.

### SUMMARY

The present disclosure provides a composition that includes a polymeric adhesive and a water-soluble polymer in water. Upon spraying, the composition provides filaments, which may be advantageous over a fine mist spray when used on a textured surface, for example.

In one aspect, the present disclosure provides a composition that includes water, a polymeric adhesive dispersed in the water or the composition, and a water-soluble polymer dissolved in the water or the composition. The water-soluble polymer has a weight average molecular weight of at least 90,000 grams per mole. Typically, and advantageously, upon spraying the composition, the composition provides filaments comprising the polymeric adhesive and the water-soluble polymer. In some embodiments, the filaments are pressure-sensitive adhesive filaments.

In another aspect, the present disclosure provides a use of a composition as a spray adhesive composition. The composition includes water, a polymeric adhesive dispersed in the water or the composition, and a water-soluble polymer having a weight average molecular weight of at least 90,000 grams per mole dissolved in the water or the composition.

In another aspect, the present disclosure provides a use of a composition as a filament-spraying adhesive. The composition includes water, a polymeric adhesive dispersed in the water or the composition, and a water-soluble polymer having a weight average molecular weight of at least 90,000 grams per mole dissolved in the water or the composition.

In the aforementioned uses, upon spraying the composition, the composition typically provides filaments comprising the polymeric adhesive and the water-soluble polymer. In some embodiments, the filaments are filaments are pressure-sensitive adhesive filaments.

In another aspect, the present disclosure provides a method of using a composition that includes water, a polymeric adhesive dispersed in the water or the composition, and a water-soluble polymer dissolved in the water or the composition. The water-soluble polymer has a weight average molecular weight of at least 90,000 grams per mole. The method includes spraying the composition to provide filaments comprising the polymeric adhesive and the water-soluble polymer. In some embodiments, the filaments are pressure-sensitive adhesive filaments.

In another aspect, the present disclosure provides a process for making the composition. The process includes combining components including a solution of the water-soluble polymer dissolved in at least a portion of the water with an emulsion of the polymeric adhesive.

In another aspect, the present disclosure provides a process for making a bonded article that includes a first substrate and a second substrate. The process includes spraying the aforementioned composition to provide the filaments comprising the polymeric adhesive and the water-soluble polymer on at least one of the first substrate or the second substrate and adhering the first substrate and the second substrate together using the filaments.

In this application, terms such as “a”, “an” and “the” are not intended to refer to only a singular entity but include the general class of which a specific example may be used for illustration. The terms “a”, “an”, and “the” are used interchangeably with the term “at least one”. The phrases “at least one of” and “comprises at least one of” followed by a list refers to any one of the items in the list and any combination of two or more items in the list. All numerical ranges are inclusive of their endpoints and non-integral values between the endpoints unless otherwise stated (e.g., 1 to 5 includes 1, 1.5, 2, 2.75, 3, 3.8, 4, and 5, and the like).

The terms “first” and “second” are used in this disclosure in their relative sense only. It will be understood that, unless otherwise noted, those terms are used merely as a matter of convenience in the description of one or more of the embodiments.

As used herein, the term “acrylic” or “acrylate” includes compounds having at least one of acrylic or methacrylic groups.

The term “(meth)acrylate” with respect to a monomer, oligomer or polymer means a vinyl-functional alkyl ester formed as the reaction product of an alcohol with an acrylic or a methacrylic acid.

The term “(co)polymer” or “(co)polymeric” includes homopolymers and copolymers, as well as homopolymers or copolymers that may be formed in a miscible blend, e.g., by coextrusion or by reaction, including, e.g., transesterification. The term “copolymer” includes random, block, graft, and star copolymers.

The term “crosslinking” refers to joining polymer chains together by covalent chemical bonds, usually via crosslinking molecules or groups, to form a network polymer. A crosslinked polymer is generally characterized by insolubility but may be swellable in the presence of an appropriate solvent.

“Alkyl group” and the prefix “alk-” are inclusive of both straight chain and branched chain groups and of cyclic groups. In some embodiments, alkyl groups have up to 30 carbons (in some embodiments, up to 25, 20, 18, 16, or 15 carbons) unless otherwise specified. Cyclic groups can be monocyclic or polycyclic.

The term “hydrocarbon” refers to compounds that have only carbon and hydrogen atoms.

The above summary of the present disclosure is not intended to describe each disclosed embodiment or every implementation of the present disclosure. The description that follows more particularly exemplifies illustrative embodiments. It is to be understood, therefore, that the drawings and following description are for illustration purposes only and should not be read in a manner that would unduly limit the scope of this disclosure.

### BRIEF DESCRIPTION OF THE DRAWINGS

The disclosure may be more completely understood in consideration of the following detailed description of various embodiments of the disclosure in connection with the accompanying drawings, in which:

FIG. 1 is an illustration of a mist spray, described in the Examples section;

FIG. 2 is an illustration of a pebble spray, described in the Examples section; and

FIG. 3 is an illustration of sprayed filaments, observable in the compositions of the present disclosure and described in the Examples.

### DETAILED DESCRIPTION

Certain solvent-based adhesives are known to produce filaments upon spraying. We have found that such adhesive filaments tend to be well-suited for rough or textured surfaces for applications such as construction or foam bonding while fine-mist adhesives are useful for smooth surfaces, lamination, and other types of thin coating applications. The filament-producing adhesives also tend to have low overspray, which results in higher transfer of adhesive to a substrate and less waste and environmental contamination.

We have observed that solvent-based and water-based adhesives behave differently upon spraying. Water-based adhesives tend to produce a fine mist when sprayed. Adhesive polymers are typically at least partially soluble solvent and readily entangled in solution, which may provide the adhesive polymer some resistance to breaking up into small droplets when the adhesive is sprayed. Low boiling solvents are generally used, and solvent evaporation may induce some drying of the adhesive during spray, thereby further preventing the formation of small droplets. Without intending to be bound by theory, we believe that these phenomena are quite challenging to achieve in water-based adhesive systems for at least the following reasons. Many adhesive polymers are not soluble in water, and water-based adhesives are generally latex materials or colloidal suspensions of discrete particles having limited interactions. Water has a higher boiling point and lower vapor pressure than solvents typically used for spray adhesives and does not evaporate during spraying in an amount sufficient to promote filament formation.

The present disclosure provides water-based compositions that typically, and advantageously, form filaments upon spraying instead of a fine mist. The composition comprises water, a polymeric adhesive dispersed in the water, and a water-soluble polymer dissolved in the water. Although this disclosure is not to be bound by theory, the water-soluble polymer, which has a weight average molecular weight of at least 90,000 grams per mole, is believed to impart sufficient entanglements to hold polymer filaments together during spraying. Adhesive filaments have advantages for some applications including greater penetration into the substrate and reduced overspray.

In some embodiments, the filaments comprising the polymeric adhesive and the water-soluble polymer are pressure-sensitive adhesive (PSA) filaments. PSAs are well known to those of ordinary skill in the art to possess properties including the following: (1) aggressive and permanent tack, (2) adherence with no more than finger pressure, (3) sufficient ability to hold onto an adherend, and typically, (4) sufficient cohesive strength to be cleanly removable from the adherend. PSAs are tacky and have the ability to adhere without activation by any energy source such as light, heat, or a chemical reaction. Materials that have been found to function well as PSAs are polymers designed and formulated to exhibit the requisite viscoelastic properties resulting in a desired balance of tack, peel adhesion, and shear holding power. One method useful for identifying pressure sensitive adhesives is the Dahlquist criterion. This criterion defines a pressure sensitive adhesive as an adhesive having a creep compliance of greater than 3×10⁻⁶ cm²/dyne as described in Handbook of Pressure Sensitive Adhesive Technology, Donatas Satas (Ed.), 2nd Edition, p. 172, Van Nostrand Reinhold, New York, NY, 1989. Alternatively, since modulus is, to a first approximation, the inverse of creep compliance, pressure sensitive adhesives may be defined as adhesives having a storage modulus of less than about 3×10⁵ N/m².

The composition of the present disclosure and/or useful for practicing the present disclosure comprises water and a polymeric adhesive dispersed in the water or the composition. By “dispersed”, it is meant that the polymeric adhesive in water is a heterogeneous mixture of discrete particles or droplets in water. “Dispersed” does not encompass “dissolved”. Generally, therefore, the polymeric adhesive is insoluble in water (that is, has a solubility of less than 5 grams (g) per liter, less than 1 g per liter, or less than 0.5 g per liter at 20° C.). The polymeric adhesive may be a liquid or solid in the water; therefore, the dispersion of polymeric adhesive in water may be an emulsion, latex, or colloidal suspension. Examples of useful polymeric adhesives that can be dispersed in water include acrylic polymers, natural rubber, synthetic polyisoprene, polybutadiene, styrene/butadiene rubber (SBR), styrene/isoprene/butadiene rubber, and acrylonitrile butadiene rubber. Various backbone geometries and connectivities may be present in these polymers, for example, in polybutadiene and polyisoprene, a high amount of cis geometry may be present. Combinations of two or more of these polymeric adhesives may be present in the composition, for example, natural rubber and SBR. In some embodiments, the polymeric adhesive comprises at least one of an acrylic polymer, natural rubber, or a copolymer of styrene with at least one of isoprene or butadiene. In some embodiments, the polymeric adhesive comprises at least one of SBR or an acrylic polymer. The polymeric adhesive dispersed in water does not include water-soluble polymers such as starch.

The weight average molecular weight (Mw) of the polymeric adhesive can be in a range from, for example, 10,000 to 1,000,000 grams per mole, 50,000 to 500,000 grams per mole, or 50,000 to 200,000 grams per mole, as determined by gel permeation chromatography using a polystyrene standard.

The polymeric adhesive dispersed in water may have a particle or droplet size in a range from 50 nanometers (nm) to 10 micrometers, from 50 nanometers to 5 micrometers, or from 200 nanometers to 500 nanometers as determined by dynamic light scattering measurements, which is a technique known to a person skilled in the art of aqueous dispersions. In some embodiments, the droplet or particle size is 500 nm or less, 400 nm or less, or 300 nm or less. In some embodiments, the droplet or particle size is at least 50 nm, at least 100 nm, or at least 130 nm.

In some embodiments, the polymeric adhesive includes an acrylic polymer. As used herein, “acrylic”, and like terms, is meant to encompass both acrylates and methacrylates. A variety of acrylic polymers may be useful in the composition. In some embodiments, the acrylic polymer is made from hydrophobic acrylic monomers including acrylate and/or methacrylate esters of a linear or branched alcohol having at least 4 carbon atoms (in some embodiments, 4 to 14 carbon atoms, 4 to 10 carbon atoms, 4 to 8 carbon atoms, or 6 to 8 carbon atoms). Examples of such monomers, which are suitable for use in the acrylic polymer, include isooctyl acrylate, 4-methyl-2-pentyl acrylate, 2-methyl-butyl acrylate, isoamyl acrylate, sec-butyl acrylate, n-butyl acrylate, 2-ethylhexyl acrylate, isodecyl methacrylate, isononyl acrylate, isodecyl acrylate, and mixtures thereof. Other suitable monomers for use in preparing the acrylic polymer include at least partially hydrophilic monomers such as acrylic acid, methacrylic acid, fumaric acid, maleic acid, itaconic acid, crotonic acid, oligomeric acrylic acid, 2-hydroxyethyl acrylate, methyl (meth)acrylate, ethyl (meth)acrylate, N-vinyl-2-pyrrolidone, and mixtures thereof. Such hydrophilic monomers are typically used in amounts of up to 2, 1, or 0.5 percent by weight, based on the total weight of monomers used to make the acrylic polymer. If acid functional groups are present in the acrylic polymer, they can be neutralized using, for example, amines (e.g., dimethylethanolamine, ammonia, triethanolamine, dimethylethyl ethanolamine, and N′,N′-dimethyl aminopropylamine) or alkali metal salts (e.g., sodium or potassium hydroxide). Other monomers may be usefully incorporated into the acrylic polymer, for example, styrene, vinyl toluene, nitriles (e.g., acrylonitrile and methacrylonitrile), vinyl and vinylidene halides, and vinyl esters (e.g., vinyl acetate).

In addition to acid-functional monomers, the acrylic polymer can further comprise monomer units of other polar monomers including at least one ketone, amide, amine, alcohol or combination thereof. Examples of polar monomers with a hydroxyl group include hydroxyalkyl (meth)acrylates (e.g., 2-hydroxyethyl (meth)acrylate, 2-hydroxypropyl (meth)acrylate, 3-hydroxypropyl (meth)acrylate, and 4-hydroxybutyl (meth)acrylate), hydroxyalkyl (meth)acrylamides (e.g., 2-hydroxyethyl (meth)acrylamide or 3-hydroxypropyl (meth)acrylamide), ethoxylated hydroxyethyl (meth)acrylate (e.g., monomers commercially available from Sartomer (Exton, PA, USA) under the trade designation CD570, CD571, and CD572), and aryloxy substituted hydroxyalkyl (meth)acrylates (e.g., 2-hydroxy-2-phenoxypropyl (meth)acrylate). Examples of polar monomers with a primary amido group include (meth)acrylamide. Examples of polar monomers with secondary amido groups include N-alkyl (meth)acrylamides such as N-methyl (meth)acrylamide, N-ethyl (meth)acrylamide, N-isopropyl (meth)acrylamide, N-tert-octyl (meth)acrylamide, and N-octyl (meth)acrylamide. Examples of polar monomers with a tertiary amido group include N-vinyl caprolactam, N-vinyl-2-pyrrolidone, (meth)acryloyl morpholine, and N,N-dialkyl (meth)acrylamides such as N,N-dimethyl (meth)acrylamide, N,N-diethyl (meth)acrylamide, N,N-dipropyl (meth)acrylamide, and N,N-dibutyl (meth)acrylamide. Polar monomers with an amino group include various N,N-dialkylaminoalkyl (meth)acrylates and N,N-dialkylaminoalkyl (meth)acrylamides. Examples include N,N-dimethyl aminoethyl (meth)acrylate, N,N-dimethylaminoethyl (meth)acrylamide, N,N-dimethylaminopropyl (meth)acrylate, N,N-dimethylaminopropyl (meth)acrylamide, N,N-diethylaminoethyl (meth)acrylate, N,N-diethylaminoethyl (meth)acrylamide, N,N-diethylaminopropyl (meth)acrylate, and N,N-diethylaminopropyl (meth)acrylamide. Examples of polar monomers that include ketones include diacetone acrylamide and acetoacetoxy ethyl methacrylate. In some embodiments, not more than 2, 1, 0.5, 0.25, 0.1, 0.05, or 0.01 percent by weight of monomer units in the acrylic polymer useful in the compositions and methods of the present disclosure include at least one ketone, amide, amine, alcohol or combination thereof. The acrylic polymer may be free of polar monomer units.

Crosslinked acrylic polymer adhesives may be made, for example, by including one or more polyfunctional crosslinking monomers (e.g., multifunctional acrylate or multifunctional methacrylate) in the monomers used to make the polymer. Suitable polyfunctional monomers include diacrylate esters of diols, such as ethylene glycol diacrylate, diethylene glycol diacrylate, propanediol diacrylate, butanediol diacrylate, butane-1,3-diyl diacrylate, pentanediol diacrylate, hexanediol diacrylate (including 1,6-hexanediol diacrylate), heptanediol diacrylate, octanediol diacrylate, nonanediol diacrylate, decanediol diacrylate, and dimethacrylates of any of the foregoing diacrylates. Further suitable polyfunctional monomers include polyacrylate esters of polyols, such as glycerol triacrylate, dipropylene glycol diacrylate, tripropylene glycol diacrylate, trimethylolpropane triacrylate, pentaerythritol tetraacrylate, neopentyl glycol diacrylate, dipentaerythritol pentaacrylate, methacrylates of the foregoing acrylates, and combinations thereof. Further suitable polyfunctional crosslinking monomers include divinyl benzene, allyl methacrylate, diallyl maleate, diallyl phthalate, and combinations thereof. Further suitable polyfunctional crosslinking monomers include polyfunctional acrylate oligomers comprising two or more acrylate groups. The polyfunctional acrylate oligomer may be a urethane acrylate oligomer, an epoxy acrylate oligomer, a polyester acrylate, a polyether acrylate, a polyacrylic acrylate, a methacrylate of any of the foregoing acrylates, or a combination thereof. Combinations of any of these crosslinking monomers may be useful. In some embodiments, not more than 1, 0.5, 0.25, 0.1, 0.05, or 0.01 percent by weight of monomer units in the acrylic polymer useful in the compositions and methods of the present disclosure are derived from crosslinking monomers. The acrylic polymer may be free of crosslinking monomer units.

Other crosslinking monomer units may be present in the acrylic polymer useful as a polymeric adhesive. In some embodiments, the acrylic polymer can undergo crosslinking upon removal of the water. N-Methylolacrylamide (NMA) is a monomer useful for incorporating an N-methylol group into an acrylic polymer, for example. The methylol group of one acrylic polymer chain can react with a methylol group of another acrylic polymer chain with cleavage of formaldehyde and water molecule to provide crosslinking. Unsaturations in silanes, such as vinylsilane and methacryloxysilanes allows incorporation into an acrylic polymer chain. Upon drying of the coating, the pH drops and triggers the hydrolysis of the alkoxysilane into a silanol (Si—OH), which then unites with a second silanol available on the polymer chain and forms a siloxane (Si—O—Si) bond. Acrylic monomers comprising an aldehyde and/or ketone functional group (e.g., diacetone acrylamide, acrolein, vinyl methyl ketone, acetoacetoxyethyl methacrylate, and allyl acetoacetate) can react with a crosslinking agent having at least two functional groups reactive with the carbonyl functionality of the acrylic copolymer. Any nitrogen-containing compound having at least two amine nitrogens reactive with carbonyl groups may be used as the crosslinking agent. Such crosslinking agents may be aliphatic or aromatic, polymeric or non-polymeric, and may be used singly or in a combination of two or more. Examples of suitable crosslinking agents include adipic acid dihydrazide, diamines (e.g., ethylenediamine, propylenediamine, tetramethylenediamine, pentamethylenediamine, hexamethylenediamine, diethylenetriamine, triethylenetetramine), and tetraaminoethylene. In some embodiments, the crosslinking agent is present in the composition in an amount such that the functional groups (e.g., hydrazide groups) reactive with the carbonyl functionality of the acrylic polymer are in a range of 0.02 to 5 equivalents, 0.1 to 3 equivalents, or 0.5 to 2 equivalents per one equivalent of carbonyl group contained in the acrylic polymer. In some embodiments of a composition of the present disclosure, after the composition is applied to a substrate and as water in the emulsion evaporates, the hydrazide groups and the carbonyl groups crosslink as a result of dehydration condensation to form cured filaments.

Polymeric adhesives dispersed in water can be made, for example, by emulsion polymerization in which monomers, such as any of those described above, are polymerized in water, optionally in the presence of an emulsifier, catalyst, and/or a chain-transfer agent (e.g., carbon tetrabromide, alcohols, mercaptans such as, for example, isooctyl thioglycolate, and mixtures thereof).

In some embodiments, the acrylic polymer useful as a polymeric adhesive is core-shell polymer having different monomer compositions in the core and the shell. A core-shell polymer can be made by emulsion polymerization, for example, in which the monomer composition is changed during the polymerization to provide polymer particles with cores having a different glass transition temperature or a different reactivity from the shell. Examples of core-shell polymers that may be useful as polymeric adhesives include those described in U.S. Pat. No. 5,461,125 (Lu et al.) and U.S. Pat. No. 10,221,343 (Qie et al.).

The various polymeric adhesives described above may have varying pH values at which they are useful. For example, natural rubber emulsions may be useful at pH 13 or 14, for example. In some embodiments, the composition of the present disclosure further comprises base, for example, to raise the pH. In some embodiments, the pH is raised to at least 7, 8, 9, 10, 11, 12, or 13. Examples of suitable bases include ammonia (e.g., aqueous ammonia or ammonium hydroxide), ethanolamine, sodium hydroxide, triethylamine, and sodium carbonate.

Some acrylic polymers useful for practicing the present disclosure are commercially available, for example, as emulsions from Alberdingk Boley, Greensboro, N.C., under the trade designations “AC 2403”, “AC 3630”, and “AC 2514”, from Dow, Midland, Mich., under the trade designation “RHOPLEX” in grades “AC-1034”, “GL-618”, and CS-4000, from The Lubrizol Corporation, Wickliffe, Ohio, under the trade designation “CARBOSET GA 7487”, from BASF, Ludwigshafen, Germany, under the trade designation “ACRONAL”, and from Arkema, King of Prussia, PA, under the trade designation “ENCOR”.

Some natural rubber polymers and SBR polymers useful for practicing the present disclosure are commercially available, for example, as emulsions from Alcan Rubber and Chemical, New York, NY, under the trade designation “ALCANTEX” and from BASF under the trade designation “BUTOFAN”.

Depending on the amount of water-soluble polymer and any of the tackifiers and other additives described below, in some embodiments, the composition of the present disclosure may include at least 70, 75, 80, 90, 95, 98, or 99 weight percent of the polymeric adhesive described above in any of its embodiments, based on the total amount of solids in the composition (that is, excluding water). In some embodiments, the polymeric adhesive is present in the composition in an amount of at least 25 percent by weight or not more than 75 percent by weight, based on the total weight of the composition (that is, including water).

The composition of the present disclosure and/or useful for practicing the present disclosure comprises a water-soluble polymer dissolved in the water or the composition. As used herein, the term water-soluble polymer refers to polymers having a solubility of at least 5 grams (g) per liter of water at 20° C. In some embodiments, the water-soluble polymer has a solubility of at least 10 g, 15 g, 20 g, 25 g, 50 g, or 100 g per liter of water at 20° C. In some embodiments, the water-soluble polymer has a solubility of up to 1000 g per liter of water at 20° C. or higher.

The water-soluble polymer has a weight average molecular weight of at least 90,000 grams per mole (g/mol) as measured by gel permeation chromatography in water against poly(methacrylic acid) standards, against polystyrene standards, or using the method described in the Examples below. Such water-soluble polymers have sufficient entanglements that when compositions of the present disclosure are sprayed, filaments comprising the polymeric adhesive and the water-soluble polymer are formed. In some embodiments, the water-soluble polymer has a weight average molecular weight of at least 95,000 g/mol, 100,000 g/mol, 125,000 g/mol, or 150,000 g/mol. In some embodiments, the water-soluble polymer has a weight average molecular weight of not more than 9,000,000 g/mol, 8,000,000 g/mol, 7,000,000 g/mol, 6,000,000 g/mol, 5,000,000 g/mol, 4,000,000 g/mol, 3,000,000 g/mol, 2,000,000 g/mol, or 1,000,000 g/mol. When the water-soluble polymer has a weight average molecular weight of less than 90,000 g/mol, it may not have sufficient entanglements to provide filaments comprising the polymeric adhesive and the water-soluble polymer when the composition is sprayed. When the water-soluble polymer has a weight average molecular weight of more than 9,000,000 g/mol, it may provide filaments that are too thick and sparse to provide good coverage of the polymeric adhesive when the composition is sprayed on a substrate.

In some embodiments, the water-soluble polymer comprises at least one of polyacrylamide, poly(ethylene oxide), poly(vinylpyrrolidone), polyvinyl alcohol or polyvinyl acetate. Such polymers can be obtained from a variety of commercial sources in a variety of molecular weights. For example, suitable, commercially available water-soluble polymers include polyvinyl alcohols from Kuraray, Okayama, Japan; polyacrylamides from Kemira, Helsinki, Finland; poly(ethylene oxide)s from DuPont, Collegeville, PA, and polyvinyl acetate available under the trade designation “VINNAPAS” from Wacker Chemical Corporation, Ann Arbor, MI. In some embodiments, the water-soluble polymer comprises at least one of polyacrylamide, poly(ethylene oxide), or poly(vinylpyrrolidone). In some embodiments, the water-soluble polymer comprises at least one of a polyacrylamide or poly(ethylene oxide). In some embodiments, the water-soluble polymer includes anionic and/or cationic groups. That is, the water-soluble polymer can be anionic, cationic, or both (i.e., amphoteric). In some embodiments, the water-soluble polymer does not include cationic groups. In some embodiments, the water-soluble polymer is nonionic. According to U.S. Pat. No. 10,113,006 (Rissanen et al.), microfibrillated cellulose is not water-soluble. In some embodiments, the water-soluble polymer is not a cellulose.

In some embodiments, the water-soluble polymer is present in the composition in an amount of at least 0.05 percent by weight (wt. %) or not more than five wt. %, based on the total weight of the composition. In some embodiments, the water-soluble polymer is present in the composition in an amount of at least 0.05 wt. %, 0.075 wt. %, or 0.1 wt. %, based on the total weight of the composition. In some embodiments, the water-soluble polymer is present in the composition in an amount of not more than 5 wt. %, 4 wt. %, 3 wt. %, 2.5 wt. %, 2 wt. %, or 1.5 wt. %, based on the total weight of the composition. In some embodiments, if the water-soluble polymer is present in the composition in an amount of less than 0.05 wt. %, it may not provide filaments comprising the polymeric adhesive and the water-soluble polymer when the composition is sprayed. In some embodiments, if the water-soluble polymer is present in the composition in an amount of more than 5 wt. %, it may negatively affect the adhesion strength of an adhesive formed from the composition.

In some embodiments of the composition of the present disclosure and/or useful for practicing the present disclosure, the composition further comprises a tackifier. In some embodiments, the tackifier comprises at least one of rosin, a rosin ester, an ester of hydrogenated rosin, a polyterpene (e.g., those based on α-pinene, β-pinene, or limonene), an aliphatic hydrocarbon resin (e.g., those based on cis- or trans-piperylene, isoprene, 2-methyl-but-2-ene, cyclopentadiene, dicyclopentadiene, or combinations thereof), an aromatic resin (e.g. those based on styrene, α-methyl styrene, methyl indene, indene, coumarone, or combinations thereof), or a mixed aliphatic-aromatic hydrocarbon resin. In some embodiments, the tackifier comprises at least one of rosin, a rosin ester, an ester of hydrogenated rosin, an aliphatic hydrocarbon resin, an aromatic resin, or a mixed aliphatic-aromatic hydrocarbon resin. The aromatic hydrocarbon resins may be C9-type petroleum resins obtained by copolymerizing a C9 fraction produced by thermal decomposition of petroleum naphtha, and aliphatic hydrocarbon resins may be C5-type petroleum resins obtained by copolymerizing a C5 fraction produced by thermal decomposition of petroleum naphtha. Mixed aliphatic/aromatic resins may be C5/C9-type petroleum resins obtained by polymerizing a combination of a C5 fraction and C9 fraction produced by thermal decomposition of petroleum naphtha. Any of these tackifying resins may be hydrogenated (e.g., partially, or completely). The term rosin, as employed herein, includes natural rosin, refined or unrefined (refined rosin will usually contain, by weight, about 90% of rosin acids and about 10% of inert material), such as natural wood rosin, natural gum rosin, and tall oil rosin; modified rosin, refined or unrefined, such as disproportionated rosin, hydrogenated rosin, and polymerized rosin; and the pure or substantially pure acids, of which rosin is comprised, alone or in admixture. In some embodiments, the tackifier is a hydrocarbon tackifier. In some embodiments, useful tackifiers can have a number average molecular weight of up to 10,000 grams per mole, a softening point of at least 30° C. as determined using a ring and ball apparatus, and a glass transition temperature of at least −30° C. as measured by differential scanning calorimetry. Useful tackifiers are typically amorphous. In some embodiments, the tackifier is miscible with the polymeric adhesive of the composition such that macroscopic phase separation does not occur in the composition. In some embodiments, a combination of tackifiers may be useful to obtain a good balance of compatibility and adhesive performance (e.g., high temperature performance).

Examples of suitable tackifiers include those obtained under the trade designations “FORAL 85E” (a glycerol ester of highly hydrogenated refined gum rosin) commercially available from Eastman, Middelburg, NL, “FORAL 3085” (a glycerol ester of highly hydrogenated refined wood rosin) commercially available from Pinova, Brunswick, GA; “ESCOREZ 2520” and “ESCOREZ 5615” (aliphatic/aromatic hydrocarbon resins) commercially available from ExxonMobil Corp., Houston, TX; “REGALITE 7100” (a partially hydrogenated hydrocarbon resin) commercially available from Eastman, Kingsport, Tennessee, and fully and partially hydrogenated hydrocarbon tackifiers obtained from Arakawa, Osaka, Japan, under the trade designation “ARKON”. Some suitable tackifiers are commercially available as emulsions under the trade designations “TACOLYN” from Eastman Chemical, Kingsport, TN, and “AQUATAC” from Kraton Corporation, Houston, TX.

In some embodiments, the tackifier is present in the composition in a range from two parts to 30 parts by weight per one hundred parts of the polymeric adhesive. In some embodiments, the tackifier is present in a range from 2 to 25, 2 to 20, 5 to 25, 10 to 25, 10 to 20, 2 to 15, or 2 to 10 parts by weight per one hundred parts of the polymeric adhesive.

In some embodiments, the composition of the present disclosure and/or useful for practicing the present disclosure further comprises an emulsifier. An emulsifier used in an emulsion polymerization to form the polymeric adhesive is typically present in the composition of the present disclosure. In some embodiments, the emulsifier is an anionic surfactant. Useful anionic surfactants include those that include at least one hydrophobic moiety such as an about 6 carbon atom- to about 12 carbon atom-alkyl, alkylaryl, and/or alkenyl group as well as at least one anionic group selected from carboxylate, sulfate, sulfonate, phosphate, polyoxyethylene sulfate, polyoxyethylene sulfonate, polyoxyethylene phosphate, and/or salts of such anionic groups such as alkali metal salts (e.g., sodium, potassium) and ammonium salts. Any fatty acid soap (e.g., alkyl succinates), ethoxylated fatty acids, and/or the alkali metal salts ammonium salts thereof, dialkylsulfosuccinates, and sulfated oils may be useful. Some useful anionic surfactants include sodium lauryl sulfate, sodium lauryl ether sulfate, sodium dodecylbenzene sulfonate and sulfosuccinate esters. Representative commercial examples of anionic surfactants include sodium lauryl sulfate, available from Stepan Chemical Co. under the trade designation “POLYSTEP B-3”; sodium lauryl ether sulfate, available from Stepan Chemical Co. under the trade designation “POLYSTEP B-12”; and sodium dodecylbenzenesulfonate, available from Rhodia, Incorporated, under the trade designation “RHODACAL DS-10”. Combinations of any of these surfactants may be useful.

In some embodiments, the emulsifier is copolymerizable with the monomer or monomer mixture and becomes incorporated into the polymeric adhesive. The copolymerizable emulsifier has at least one group, or only one group, capable of reacting with the monomer or monomer mixture. Such reactive groups include ethylenically unsaturated groups such as vinyl groups and acrylate groups. Examples of polymerizable emulsifiers include sodium styrene sulfonate (commercially available from Alfa Aesar), sodium vinylsulfonate, polysodium styrene sulfonate, polyoxyethylene alkylphenyl ether ammonium sulfates those obtained under the trade designation “HITENOL BC” from Montello, Inc., Kyoto, Japan, including polyoxyethylene nonylpropenyl phenyl ether ammonium sulfate, polyoxyethylene styrenated phenyl ether ammonium sulfates such as those obtained under the trade designation “HITENOL AR” from Montello, Inc., and polyoxyethylene alkylether sulfuric esters such as those obtained under the trade designation “HITENOL KH” from Montello, Inc.

The total amount of surfactant in the composition of the present disclosure and/or useful for practicing the present disclosure is typically 5 wt. % or less, 3 wt. % or less, 2 wt. % or less, 1.75 wt. % or less, 1.5 wt. % or less, or 1.3 wt. % of less based on the total weight of the solids in the composition (that is, excluding water). In some embodiments, the total amount of emulsifier employed is anionic in nature.

In some embodiments a small amount (e.g., less than 5 wt. % of the total surfactant amount) of nonionic surfactant may be employed if desired. Such surfactants are well known to those skilled in the art. Representative commercial examples of nonionic surfactants include the “TRITON X” series of surfactants (octylphenol ethoxylates), “TRITON CG 600” (a polyalkyl glucoside) available from Dow Chemical Company, and polymerizable surfactants including polyoxyethylene alkylphenyl ethers such as those obtained under the trade designation “NOIGEN RN” from Montello, Inc.

In addition to the polymeric adhesive, water-soluble polymer, tackifier, and emulsifier as described above in any of their embodiments and water, the following additives may also optionally be included in the compositions of the present disclosure and/or useful for practicing the present disclosure: inhibitors such as hydroquinone, pigments, dyes, rheology modifiers, thickeners, plasticizers, antioxidants (e.g., hindered phenols, amines, and sulfur and phosphorous hydroperoxide decomposers), stabilizers (e.g., ultraviolet absorbers, hindered amine light stabilizers, and heat stabilizers), fillers (e.g., inorganic fillers such as talc, zinc oxide, titanium dioxide, aluminum oxide), preservatives, biocides, corrosion inhibitors, fire retardants, and defoamers. These and other conventional additives, if used, are present in conventional concentrations known to those skilled in the art and to the extent they do not unacceptably affect the advantages provided by the present disclosure.

The composition of the present disclosure and/or useful for practicing the present disclosure includes water. The amount of water in the composition is typically at least 25 wt. % or 30 wt. %, based on the total weight of the composition. The amount of water in the composition can be up to 75 wt. %, 70 wt. %, 65 wt. %, 60 wt. %, 55 wt. %, 50 wt. %, 45 wt. %, or 40 wt. % by weight, based on the total weight of the composition. Useful amount of water in the compositions can be in a range from 25 wt. % to 55 wt. %, 25 wt. % to 50 wt. %, or 30 wt. % to 40 wt. %, based on the total weight of the composition.

In some embodiments, the composition of the present disclosure and/or useful for practicing the present disclosure exhibits a viscosity of 12,000 centipoise (12,000 mPa-s) or less as determined using a Brookfield Viscometer, spindle 6, at 20 rpm. In some embodiments, the viscosity of the composition is not more than 10,000 centipoise (10,000 mPa-s), 7500 centipoise (75000 mPa-s), 5000 centipoise (5000 mPa-s), 3000 centipoise (3000 mPa-s), or 1000 centipoise (1000 mPa-s). In some embodiments, the composition has a viscosity of at least 300 centipoise (300 m Pa-s) or at least 500 centipoise (500 m Pa-s).

In some embodiments, the composition of the present disclosure and/or useful for practicing the present disclosure is substantially free of organic solvents. Common organic solvents include any of those have a boiling point of up to 150° C. at atmospheric pressure. The term “substantially free” means that composition can include up to 0.5, 0.1, 0.05, or 0.01 percent by weight of any of these solvents or can be free of any of these solvents. These percentages are based on the total weight of the composition.

In some embodiments, the composition of the present disclosure and/or useful for practicing the present disclosure further comprises organic solvent. Useful organic solvents include those that are compatible with water and can provide a homogeneous composition. Examples of useful solvents include esters (e.g., methyl acetate and butyl acetate), alcohols (e.g., methanol, ethanol, and isopropyl alcohol), polyols (e.g., ethylene glycol, propylene glycol, and glycerol), and ketones (e.g., acetone). In some embodiments, the organic solvent comprises at least one of ethyl acetate, ethanol, or acetone. The total amount of organic solvent is typically 20 wt. % or less, 10 wt. % or less or 5 wt. % or less, or 1 wt. % or less, and may be more than 0.5 wt. %, at least 1 wt. %, at least 2 wt. %, at least 3 wt. %, at least 4 wt. %, or at least 5 wt. %, based on the total weight of the composition. Such solvents may useful, for example, for keeping the water-soluble polymer dissolved in the presence of the polymeric adhesive dispersed in the composition.

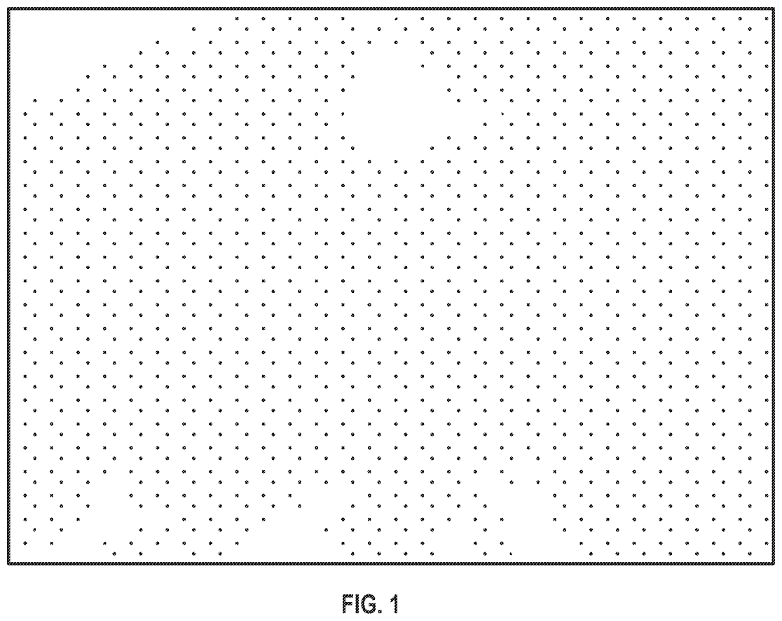

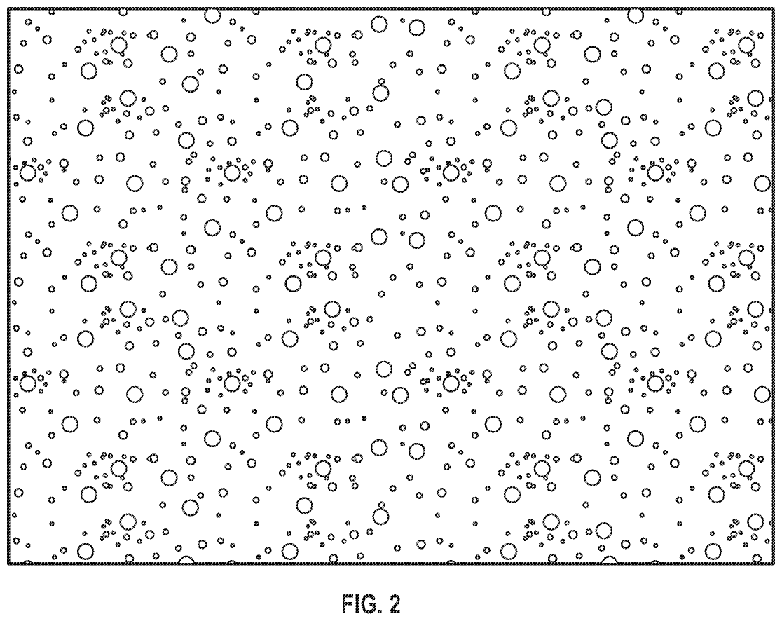

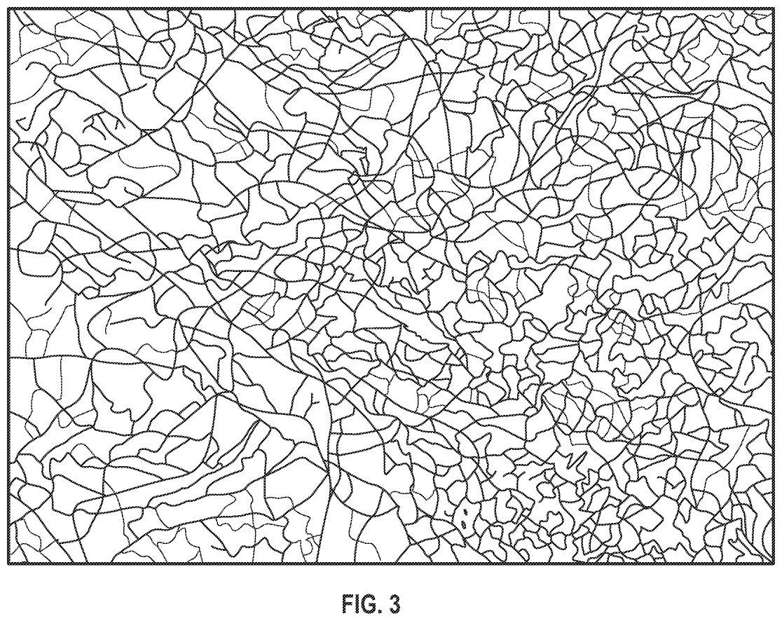

The present disclosure provides the use of the composition of the present disclosure as described above in any of its embodiments as a spray adhesive composition and/or as a filament-spraying adhesive. The method of using the composition of the present disclosure includes spraying the composition as described above in any of its embodiments to provide filaments comprising the polymeric adhesive and the water-soluble polymer. The spray pattern provided by the composition may include a combination of filaments and other features such as large or small droplets. Such combination patterns are also useful for many adhesive applications. While droplets typically have an aspect ratio of about 1:1, filaments produced by spraying the composition of the present disclosure typically have a length to width aspect ratio of at least 2:1, 3:1, 5:1, 10:1, 100:1, or greater, wherein the length is the longest dimension of the filament, and the width is a dimension perpendicular to the length. Compositions of the present disclosure typically provide a web of interconnected filaments as shown in FIG. 3. The Examples, below, demonstrate that commercially available water-based adhesives form a fine mist spray. For Example, in Comparative Examples 1 to 3, acrylic emulsions were sprayed onto a surface, and a spray pattern generally represented in FIG. 1 was formed. When a water-soluble polymer was added to the acrylic emulsions, either a spray pattern generally represented in FIG. 3, including filaments, or having a combination of a spray pattern represented by FIG. 2 (pebble spray) and FIG. 3 (including filaments) was formed. As shown in Table 3, reporting the overlap shear strength of birch wood substrates bonded with Example and Comparative Example compositions, the adhesive strength of the polymeric adhesive may be maintained when the water-soluble polymer is added.

In some embodiments, the composition of the present disclosure and/or useful for practicing the present disclosure is packaged in a spray container. Any of a variety of different spray containers may be useful for delivering the composition of the present disclosure and may be useful in the method of using a composition or the process for making a bonded article according to the present disclosure. For example, an air-assisted spray system may be useful. Examples of useful air-assisted spray systems include those obtained under the trade designation “3M Accuspray ONE Spray Gun System with Standard PPS” and “3M Accuspray Paint Spray System with PPS 2.0” from 3M Company, St. Paul, Minnesota. Thus, the spray container may be a disposable cup or cup and disposable liner attached to a spray gun with an atomizing head or nozzle. Spray can be assisted using compressed air, for example, at pressures in a range from 0.13 Megapascals (MPa) to 0.21 MPa.

In other embodiments, an airless spray system may be useful for the composition and methods of the present disclosure. Pressure pots such as one-liter capacity pots with pressure rating up to 225 psi (1.24 MPa), obtained, for example, from Apache Stainless Steel Equipment Corporation, Beaver Dam, Wisconsin can be connected to a nylon hose obtained, for example, under the trade designation “3M Cylinder Adhesive Hose” from 3M Company, St. Paul, Minnesota. The hose can be, for example, up to 8, 7, 6, 5, 4, 3, 2, or 1 meter long. A high throughput metallic spray gun obtained, for example, under the trade designations “GunJet” and “H GunJet” from Spray Systems Co., Minnetonka, Minnesota, with a brass spray nozzle obtained, for example, under the trade designations “4001 UniJet”, “6501 UniJet”, “9501 UniJet”, “1100050 UniJet”, and “800050 UniJet” from Spray Systems Co. may conveniently attached to the hose. The canister can be pressurized with dry nitrogen gas or any desirable gas.

In other embodiments, aerosol cans may be useful for the composition and methods of the present disclosure. Aerosol cans can be obtained from a variety of sources, for example, from Ball Metalpack, Broomfield, Colorado, under the trade designation “Classic Tinplate Can”. Any aerosol actuator, for example, that obtained under the trade designation “Seaquist 802-24-20/0890-20FS” from Aptar, Mukwonago, Wisconsin, with Buna valves obtained under the trade designation “AR-83” from Aptar, may be useful. Aerosols typically include a propellant. Examples of suitable propellants include nitrogen, carbon dioxide, ethane, propane, isobutane, normal butane, dimethyl ether, 1,1-difluoroethane, trans-1,3,3,3-tetrafluoropropene, and mixtures thereof. Typically, liquid aerosol propellants such as propane, butane, and isobutane are added to the composition in an amount ranging from about 5 wt. % to about 45 wt. %, based on the total weight of the composition. When gases such as nitrogen and carbon dioxide are used as the propellant, the gas propellant is typically present in an amount ranging up to about 10 wt. %, 8 wt. %, 6 wt. %, 5 wt. %, or 2 wt. % by weight, based on the total weight of the composition.

The process for making the composition of the present disclosure includes combining components comprising a solution of the water-soluble polymer dissolved in at least a portion of the water with an emulsion of the polymeric adhesive. It is also possible to combine a neat water-soluble polymer and the emulsion of the polymeric adhesive. Other components may be combined into the composition as solids, liquid, dissolved in water, or emulsified in water. In embodiments in which the composition includes a tackifier, a second emulsion of the tackifier may be combined with an emulsion of the polymeric adhesive and the solution of the water-soluble polymer. The order of addition is not limited. In some embodiments, the emulsion that includes the polymeric adhesive also includes the tackifier. In some embodiments, the monomers used to make the polymeric adhesive may be polymerized in the presence of the tackifier. For example, a tackifier and at least one alkyl (meth)acrylate may be combined to form a solution, which may be combined with the water and the emulsifier. The at least one alkyl (meth)acrylate may then be polymerized to form an emulsion with droplets that include both the acrylic polymer and the tackifier. The solution can include any of the other optional monomers described above.

The process according to the present disclosure for making a bonded article that includes a first substrate or a second substrate includes spraying the composition of the present disclosure or made by the process of the present disclosure to provide the filaments comprising the polymeric adhesive and the water-soluble polymer on at least one of the first substrate or the second substrate. The process further includes adhering the first substrate and the second substrate together using the filaments. The present disclosure provides an article that comprises a first substrate and a second substrate bonded together with a composition of the present disclosure. The surfaces of the first substrate and the second substrate may be any desired material. In some embodiments, at least one of the surfaces of the first substrate or the surface of the second substrate comprises at least one of metal, glass, a polymer, paper, a painted surface, a nonwoven or woven fabric, or a composite. The material of the surface of the first and second substrate may be found throughout the substrate, or the surface may include a different material from the bulk of the substrate. In some embodiments, the surface of the first substrate and/or second substrate comprises at least one of metal (e.g., steel, stainless steel, or aluminum), glass (e.g., which may be coated with indium tin oxide, for example,), a polymer (e.g., a plastic, rubber, thermoplastic elastomer, or thermoset), paper, a painted surface, or a composite. A composite material may be made from any two or more constituent materials with different physical or chemical properties. When the constituents are combined to make a composite, a material having characteristics different from the individual components is typically achieved. Some examples of useful composites include fiber-reinforced polymers (e.g., carbon fiber reinforced epoxies and glass-reinforced plastic), metal matrix compositions, and ceramic matrix composites. The surface of at least one of the first or second substrates may include polymers such as polyolefins (e.g., polypropylene, polyethylene, high density polyethylene, blends of polypropylene), polyamide 6 (PA6), acrylonitrile butadiene styrene (ABS), polycarbonate (PC), PC/ABS blends, polyvinyl chloride (PVC), polyamide (PA), polyurethane (PUR), thermoplastic elastomers (TPE), polyoxymethylene (POM), polystyrene, polyester (e.g., polyethylene terephthalate), poly(methyl) methacrylate (PMMA), and combinations thereof. The surface of at least one of the first or second substrate may also include a metal coating on such polymers. In some embodiments, at least one of the first or second substrate comprises a transparent material such as glass or a polymer (e.g., acrylic or polycarbonate).

In some embodiments, at least one of the first substrate or second substrate has a textured surface. Textured surfaces are common in construction. In some embodiments, at least one of the first substrate or second substrate is a fibrous substrate or a foam substrate (e.g., a polymer foam such as polyurethane, EPDM, and polyethylene foam).

Fibrous substrates include woven or nonwoven fabric. The term “nonwoven” refers to a material having a structure of individual fibers or threads that are interlaid but not in an identifiable manner such as in a knitted fabric. Examples of nonwoven webs include spunbond webs, spunlaced webs, needle-punched webs, airlaid webs, meltblown web, and bonded carded webs. Useful nonwovens may be made of natural fibers (e.g., wood or cotton fibers), synthetic fibers (e.g., thermoplastic fibers), or a combination of natural and synthetic fibers. Examples of suitable materials for forming thermoplastic fibers include polyolefins (e.g., polyethylene, polypropylene, polybutylene, ethylene copolymers, propylene copolymers, butylene copolymers, and copolymers and blends of these polymers), polyesters, and polyamides. The fibers may also be multi-component fibers, for example, having a core of one thermoplastic material and a sheath of another thermoplastic material. Examples of woven fabrics include twill and canvas.

In some embodiments, at least one of the first substrate or the second substrate is a low surface energy substrate. The term “low surface energy substrate” is meant to refer to those substrates having a surface energy of less than 34 dynes per centimeter. Included among such materials are polypropylene, polyethylene [e.g., high density polyethylene (HDPE), low density polyethylene (LDPE), and liner low density polyethylene (LLDPE)], and blends of polypropylene (e.g., PP/EPDM, TPO). In some embodiments, at least one of the first substrate or the second substrate is a medium surface energy substrate. The term “medium surface energy substrates” is meant to refer to those substrates having a surface energy in a range from 34 to 70 dynes per centimeter, typically from 34 to 60 dynes per centimeter, and more typically from 34 to 50 dynes per centimeter. Included among such materials are polyamide 6 (PA6), acrylonitrile butadiene styrene (ABS), polycarbonate (PC)/ABS blends, PC, PVC, polyamide (PA), polyurethane (PUR), thermoplastic elastomers (TPE), polyoxymethylene (POM), polystyrene, and poly(methyl methacrylate) (PMMA). The surface energy is typically determined from contact angle measurements as described for example in ASTM D7490-08.

The composition of the present disclosure can be useful in a variety of applications. The composition of the present disclosure can also be useful for bonding dissimilar materials together. In some of these embodiments, the first substrate comprises a metal, and the second substrate comprises a rubber or plastic. In some embodiments, the first and second substrates are dissimilar plastics. The composition of the present disclosure can also be useful for foam lamination in which either the first or second substrate is a foam (e.g., a polymer foam such as polyurethane, EPDM, and polyethylene foam). The composition of the present disclosure can also be useful for packaging in which either the first or second substrate is a paper (e.g., polymer-coated paper) or paperboard.

The composition according to the present disclosure and/or useful for practicing the present disclosure typically and advantageously does not require an external coagulant, such as citric acid, lactic acid, acetic acid, or zinc sulfate. Thus, the method of making a bonded article comprising a first substrate and a second substrate does not require a second part including such a coagulant in a predetermined ratio with the composition of the present disclosure. Thus, the compositions and methods of the present disclosure avoid disadvantages associated with a two-part system, for example, the co-spraying equipment being expensive and requiring maintenance and the complexity of monitoring the ratio of the two parts (i.e., the coagulant and the adhesive composition). Furthermore, the spray adhesive composition or composition according to the present disclosure and/or made by the process of the present disclosure does not require a chemical reaction to take place upon spraying or after spraying for filament formation.

### Some Embodiments of the Disclosure

In a first embodiment, the present disclosure provides a composition comprising water, a polymeric adhesive dispersed in the water or in the composition, and a water-soluble polymer dissolved in the water or in the composition, wherein the water-soluble polymer has a weight average molecular weight of at least 90,000 grams per mole. In a second embodiment, the present disclosure provides the composition of the first embodiment, wherein upon spraying the composition, the composition provides filaments comprising the polymeric adhesive and the water-soluble polymer. In a third embodiment, the present disclosure provides the composition of the first or second embodiment, wherein the composition is a spray adhesive composition.

In a fourth embodiment, the present disclosure provides the composition of any one of the first to third embodiments, wherein the polymeric adhesive comprises at least one of an acrylic polymer, natural rubber, synthetic polyisoprene, polybutadiene, styrene/butadiene rubber, styrene/isoprene/butadiene rubber, or acrylonitrile butadiene rubber. In a fifth embodiment, the present disclosure provides the composition of the fourth embodiment, wherein the polymeric adhesive comprises at least one of an acrylic polymer or styrene/butadiene rubber. In a sixth embodiment, the present disclosure provides the composition or spray adhesive composition of the third or fourth embodiment, further comprising a tackifier. In a seventh embodiment, the present disclosure provides the composition of the sixth embodiments, wherein the tackifier comprises at least one of a rosin acid, a rosin ester, a C5 aliphatic hydrocarbon resin, a C9 aromatic resin, or a mixed aliphatic-aromatic hydrocarbon resin. In an eighth embodiment, the present disclosure provides the composition of the sixth or seventh embodiments, wherein the tackifier is present in the composition in a range from two parts to 30 parts per one hundred parts of acrylic polymer.

In a ninth embodiment, the present disclosure provides the composition of any one of the first to eighth embodiments, wherein the water-soluble polymer comprises at least one of polyacrylamide, poly(ethylene oxide), poly(vinylpyrrolidone), polyvinyl alcohol, or polyvinyl acetate. In a tenth embodiment, the present disclosure provides the composition of any one of the first to ninth embodiments, wherein the water-soluble polymer comprises at least one of polyacrylamide, poly(ethylene oxide), or poly(vinylpyrrolidone). In an eleventh embodiment, the present disclosure provides the composition of any one of the first to tenth embodiments, wherein the water-soluble polymer is nonionic. In a twelfth embodiment, the present disclosure provides the composition of any one of the first to eleventh embodiments, wherein the water-soluble polymer has a weight average molecular weight of not more than 9,000,000, 8,000,000, 7,000,000, 6,000,000, 5,000,000, 4,000,000, 3,000,000, 2,000,000, or 1,000,000 grams per mole. In a thirteenth embodiment, the present disclosure provides the composition of any one of the first to twelfth embodiments, wherein the water-soluble polymer is present in the composition in an amount of at least 0.05 percent by weight or not more than five percent by weight, based on the total weight of the composition.

In a fourteenth embodiment, the present disclosure provides the composition of any one of the first to thirteenth embodiments, wherein the polymeric adhesive is present in the composition in an amount of at least 25 percent by weight or not more than 75 percent by weight, based on the total weight of the composition. In a fifteenth embodiment, the present disclosure provides the composition of any one of the first to fourteenth embodiments, wherein the filaments comprising the polymeric adhesive and the water-soluble polymer are pressure-sensitive adhesive filaments. In a sixteenth embodiment, the present disclosure provides the composition of any one of the first to fifteenth embodiments, further comprising a propellent.

In a seventeenth embodiment, the present disclosure provides the composition of any one of the first to sixteenth embodiments, packaged in a spray container. In an eighteenth embodiment, the present disclosure provides the composition of any one of the first to seventeenth embodiments, further comprises at least one of acetone, ethanol, or methyl acetate in an amount of greater than 0.5 weight percent or at least 1, 2, 3, or 4 weight percent and up to 20, 10, or 5 weight percent, based on the total weight of the composition. In an nineteenth embodiment, the present disclosure provides a use of the composition of any one of the first to eighteenth embodiments as a spray adhesive composition. In a twentieth embodiment, the present disclosure provides a use of the composition of any one of the first to eighteenth embodiments as a filament-spraying adhesive. In a twenty-first embodiment, the present disclosure provides a method of using the composition of any one of the first to eighteenth embodiments, the method comprising spraying the composition to provide filaments comprising the polymeric adhesive and the water-soluble polymer.

In a twenty-second embodiment, the present disclosure provides a process for making the composition of any one of the first to eighteenth embodiments, the process comprising combining components comprising a solution of the water-soluble polymer dissolved in at least a portion of the water with an emulsion of the polymeric adhesive. In a twenty-third embodiment, the present disclosure provides the process of the twenty-second embodiment, wherein the emulsion further comprises a tackifier. In a twenty-fourth embodiment, the present disclosure provides the process of the twenty-third embodiment, wherein the components further comprise a second emulsion of a tackifier.

In a twenty-fifth embodiment, the present disclosure provides a method of making a bonded article comprising a first substrate and a second substrate, the method comprising spraying the composition of any one of the first to eighteenth embodiments to provide the filaments comprising the polymeric adhesive and the water-soluble polymer on at least one of the first substrate or the second substrate and adhering the first substrate and the second substrate using the filaments. In a twenty-sixth embodiment, the present disclosure provides the method of the twenty-fifth embodiment, wherein at least one of the first substrate or the second substrate has a textured surface. In a twenty-seventh embodiment, the present disclosure provides the method of the twenty-fifth or twenty-sixth embodiment, wherein at least one of the first substrate or the second substrate is a foam.

In order that this disclosure can be more fully understood, the following examples are set forth. It should be understood that these examples are for illustrative purposes only and are not to be construed as limiting this disclosure in any manner.

### EXAMPLES

Unless otherwise noted, all parts, percentages, ratios, etc. in the Examples and the rest of the specification are by weight.

TABLE 1
Materials List

| Abbreviation | Description |
|---|---|
| PA 1 | Polyacrylamide flocculant, obtained under the trade designation “SUPERFLOC N- |
| | 300”, from Kemira, Helsinki Finland |
| PEO 1 | Poly(ethylene oxide), obtained under the trade designation “POLYOX WSR 205”, |
| | from DuPont, Collegeville, PA |
| PEO 2 | Poly(ethylene oxide), obtained under the trade designation “POLYOX WSR |
| | N750”, from DuPont |
| PEO 3 | Poly(ethylene oxide), obtained under the trade designation “POLYOX WSR 301”, |
| | from DuPont |
| PVP | Poly(vinyl pyrrolidone) 360,000 g/mol, obtained from Sigma Aldrich, St. Louis, |
| | MO |
| Acrylic 1 | Acrylic insulation attachment adhesive, obtained under the trade designation |
| | “Fastbond 49”, from 3M Company, Springfield, MO |
| Acrylic 2 | Acrylic emulsion, obtained under the trade designation “ACRONAL V 212”, from |
| | BASF, Ludwigshafen, Germany |
| SBR | Styrene butadiene rubber dispersion adhesive, obtained under the trade designation |
| | “BUTOFAN NS 222”, from BASF |
| Acrylic 3 | Acrylic emulsion adhesive, obtained under the trade designation “ENCOR 9466”, |
| | from Arkema, King of Prussia, PA |

### Adhesive Spraying Method

All adhesives were sprayed with air assisted sprayers (obtained under the trade designation “3M Accuspray PPS ONE Spray Gun System with Standard PPS” and “3M Accuspray Paint Spray System with PPS 2.0” from 3M Company, Lindstrom, Minnesota). The adhesive was fed through the gun with a gravity feed cup on the back and a disposable 1.8-millimeter (mm) diameter plastic disposable nozzle (obtained under the trade designation “Accuspray Atomizing Head” from 3M Company, Lindstrom, Minnesota). The gravity feed cup was filled with approximately 100 grams (g) of each adhesive formulation. Air pressures ranged from 10 to 30 pounds per square inch (psi) obtained using house compressed air through a gas regulator attached to the bottom of the gun. The adhesive was sprayed from 10 to 25 centimeters (cm) away from the paper and was sprayed at a rate of 6 to 10 g/second in 30- to 60-cm spray strokes.

### Spray Pattern Characterization.

The spray patterns from the Adhesive Spraying Method were characterized using the following categories. A “mist’ spray is defined as a finely atomized spray pattern with very small droplets of less than 1 to 2 mm in diameter. A “pebble” spray is defined as a mixture of a fine mist and larger droplets on the order of 1 to 5 mm in diameter. “Filament” spray pattern is defined as a spray pattern which produces filaments or strands of liquid adhesive on the surface. The spray patterns are reported in Table 2 by a number. A “mist” spray is rated “1”. A “pebble” spray is rated “2”. “Filament” patterns are rated “3”. Half numbers were also used when the spray pattern was between two ratings. Spray ratings were identified by reporting the average spray pattern after dispensing approximately 100 g through the spray applicator and are reported in Table 2.

### Overlap Shear (OLS) Testing

Birch wood substrates (2.54 cm×10.16 cm×0.32 cm panels, obtained from Forest Product Supply, St. Paul, Minnesota) were used to analyze the bond strength of certain of the Examples. The birch panels were taped off so that only 2.54 cm² were exposed. The adhesive was applied with a PPS gun as detailed above in the “Adhesive Spray Test Method” and the adhesive was applied at 30 to 50 grams per square meter. Once the adhesive was sprayed onto the substrate, the bonds were joined within 5 minutes (min), held with a binder clip, and allowed to dwell for 16 to 24 hours. Overlap shear strength was tested on a tensile tester (“QTEST_5”, from MTS Systems Corporation, Eden Prairie, Minnesota) with samples pulled at a rate of 5.08 cm/min, and strength at break was recorded in kilopascals (kPa). The data reported in Table 3 are an average of three samples.

### Examples (EX) 1 to 18 and Comparative Examples (CE) 1 to 3

First, a 1-liter (1-L) stock solution of water-soluble polymer (referred to as “Polymer”) was first prepared. The “Polymer Solution Concentration” in Table 2 shows the weight percentage (wt %) of the 1-L stock solution. The polymer powder or pellet was added to a glass jar followed by addition of water up to a volume of 1-L and rolled overnight. Then, the appropriate water-based adhesive was added to a glass jar in amounts from Table 2. An overhead stirrer (obtained under the trade designation “Hei-Torque Core Overhead Stirrer” from Heidolph Instruments, Wood Dale, Illinois) with a glass overhead stir shaft (obtained under the trade designation “Kimble Kontes Stirrer Shaft”, from DWK Life Sciences, Millville, New Jersey) and a PTFE stir blade (obtained under the trade designation “Kimble Kontes PTFE Stirrer Blade” from DWK Life Sciences) was used to mix the formulations listed in Table 2. With stirring, the solution of water-soluble polymer was added slowly over 5 min. Then the mixture was allowed to stir for an additional 10 min. Amounts and concentrations of the components of Examples 1 to 18 are listed in Table 2, below. Polymer wt % refers to the wt % of the polymer in the composition including water, the polymeric adhesive, and the water-soluble polymer. Comparative Examples 1 to 3 were adhesive compositions as commercially obtained.

### Weight Average Molecular Weight Determination

The weight average molecular weights of poly(ethylene oxide) samples can be determined by comparison to narrow distribution poly(ethylene oxide) standards using gel permeation chromatography (GPC). The GPC measurements can be carried out on an Agilent 1100 instrument (obtained from Agilent Technologies, Santa Clara, Cal.) using an Agilent Plgel Mixed-C 5p 30 cm×7.5 mm column (obtained from Agilent Technologies) for a sample having a molecular weight of less than 500,000 grams per mole and an Agilent Plgel Mixed-A 20p 30 cm×7.5 mm column (obtained from Agilent Technologies) for a higher molecular weight sample. A refractive index detector can be used at 40° C. Solutions can be made of the PEG samples at 25 mg per 20 mL of 1:1 stabilized tetrahydrofuran/chloroform. Samples can be swirled overnight to ensure complete solution. A sample volume of 50 microliters can be injected onto the Agilent Plgel Mixed-C 5p 30 cm×7.5 mm column at a column temperature of 40° C. Sample volumes of 25 microliters and 50 microliters were injected onto the Agilent Plgel Mixed-A 20p 30 cm×7.5 mm column. A flow rate of 0.6 mL/minute can be used, and the mobile phase can be 1:1 stabilized tetrahydrofuran/chloroform. Molecular weight calibration can be performed using narrow distribution poly(ethylene oxide) standards from Agilent Technologies, dissolved in 1:1 stabilized THF/chloroform at about 5-10 mg per 20 mL solvent. These cover a molecular weight range of 1.7 MDa down to 600 Da. Calibration and molecular weight distribution calculations can be performed using suitable GPC software using a third order polynomial fit for the molecular weight calibration curve. Modifications of columns and calibration standards can be made by a person skilled in the art for other water-soluble polymers, if desired.

TABLE 2
Formulations and Spray Rating for EX 1 to 18 and CE 1 to 3

| | | Adhesive | | Polymer | Polymer | | |
|---|---|---|---|---|---|---|---|
| EX or | | Amount | | Solution | Solution | Polymer | Spray |
| CE | Adhesive | (g) | Polymer | Concentration | Amount (g) | wt % | Rating |
| CE 1 | Acrylic 1 | 100 | none | n/a* | n/a | n/a | 1 |
| CE 2 | Acrylic 2 | 100 | none | n/a | n/a | n/a | 1 |
| CE 3 | Acrylic 3 | 100 | none | n/a | n/a | n/a | 1 |
| 1 | Acrylic 1 | 45 | PA 1 | 1% | 5 | 0.1 | 2.5 |
| 2 | Acrylic 1 | 37.5 | PA 1 | 1% | 12.5 | 0.25 | 3 |
| 3 | Acrylic 2 | 46.9 | PA 1 | 1% | 3.1 | 0.06 | 2.5 |
| 4 | Acrylic 2 | 43.7 | PA 1 | 1% | 6.3 | 0.13 | 3 |
| 5 | SBR | 46.9 | PA 1 | 1% | 3.1 | 0.06 | 2.5 |
| 6 | SBR | 43.7 | PA 1 | 1% | 6.3 | 0.13 | 3 |
| 7 | Acrylic 3 | 46.9 | PA 1 | 1% | 3.1 | 0.06 | 2.5 |
| 8 | Acrylic 3 | 43.7 | PA 1 | 1% | 6.3 | 0.13 | 3 |
| 9 | Acrylic 2 | 200 | PEO 3 | 3% | 15 | 0.2 | 3 |
| 10 | Acrylic 2 | 200 | PEO 1 | 3% | 15 | 0.2 | 3 |
| 11 | Acrylic 2 | 200 | PEO 1 | 3% | 30 | 0.4 | 3 |
| 12 | Acrylic 2 | 200 | PEO 2 | 3% | 20 | 0.3 | 3 |
| 13 | Acrylic 2 | 200 | PEO 2 | 3% | 40 | 0.5 | 3 |
| 14 | Acrylic 2 | 200 | PVP | 10% | 12 | 0.6 | 2.5 |
| 15 | Acrylic 2 | 200 | PVP | 10% | 24 | 1.1 | 3 |
| 16 | Acrylic 2 | 200 | PVP | 10% | 36 | 1.5 | 3 |
| 17 | Acrylic 3 | 100 | PEO 1 | 3% | 6.3 | 0.18 | 3 |
| 18 | Acrylic 3 | 100 | PVP | 10% | 11 | 1.0 | 3 |

*n/a means not applicable

TABLE 3
Overlap Shear Data

| Example | Adhesive | Polymer | Polymer wt % | Birch OLS (kPa) |
|---|---|---|---|---|
| CE 2 | Acrylic 2 | None | n/a | 407 |
| 10 | Acrylic 2 | PEO 1 | 0.2 | 421 |
| 12 | Acrylic 2 | PEO 2 | 0.3 | 364 |
| 15 | Acrylic 2 | PVP | 1.1 | 579 |

This disclosure is not limited to the above-described embodiments but is to be controlled by the limitations set forth in the following claims and any equivalents thereof. This disclosure may be suitably practiced in the absence of any element not specifically disclosed herein.

1. A composition comprising:
water;
a polymeric adhesive dispersed in the composition; and
a water-soluble polymer dissolved in the composition, wherein the water-soluble polymer has a weight average molecular weight of at least 90,000 grams per mole,
wherein upon spraying the composition, the composition provides filaments comprising the polymeric adhesive and the water-soluble polymer.

2. The composition of claim 1, wherein the polymeric adhesive comprises at least one of an acrylic polymer, natural rubber, synthetic polyisoprene, polybutadiene, styrene/butadiene rubber, styrene/isoprene/butadiene rubber, or acrylonitrile butadiene rubber.

3. The composition of claim 1, further comprising a tackifier, wherein the tackifier comprises at least one of a rosin acid, a rosin ester, a C5 aliphatic hydrocarbon resin, a C9 aromatic resin, or a mixed aliphatic-aromatic hydrocarbon resin.

4. The composition of claim 1, wherein the water-soluble polymer comprises at least one of polyacrylamide, poly(ethylene oxide), poly(vinylpyrrolidone), polyvinyl alcohol, or polyvinyl acetate.

5. The composition of claim 1, wherein the water-soluble polymer is nonionic.

6. The composition of claim 1, wherein the water-soluble polymer is present in the composition in an amount of at least 0.1 percent by weight or not more than five percent by weight, based on the total weight of the composition.

7. The composition of claim 1, wherein the water-soluble polymer has a weight average molecular weight of not more than 9,000,000 grams per mole.

8. The composition of claim 1, wherein the polymeric adhesive is present in the composition in an amount of at least 25 percent by weight or not more than 75 percent by weight, based on the total weight of the composition.

9. The composition of claim 1, wherein the filaments comprising the polymeric adhesive and the water-soluble polymer are pressure-sensitive adhesive filaments.

10. The composition of claim 1, further comprising a propellant.

11. The composition of claim 1, further comprising at least one of acetone, ethanol, or methyl acetate in an amount of greater than 0.5 weight percent and up to 20 weight percent, based on the total weight of the composition.

12. A process for making the composition of claim 1, the process comprising:
combining components comprising a solution of the water-soluble polymer dissolved in at least a portion of the water with an emulsion of the polymeric adhesive.

13. The process of claim 12, wherein the emulsion further comprises a tackifier.

14. A method of making a bonded article comprising a first substrate and a second substrate, the method comprising:
spraying the composition of claim 1 to provide the filaments comprising the polymeric adhesive and the water-soluble polymer on at least one of the first substrate or the second substrate; and
adhering the first substrate and the second substrate using the filaments.

15. (canceled)

16. The method of claim 14, wherein at least one of the first substrate or the second substrate has a textured surface.

17. The method of claim 14, wherein at least one of the first substrate or the second substrate is a foam.

18. The process of claim 12, wherein the components further comprise a second emulsion of a tackifier.

19. The composition of claim 1, wherein the water-soluble polymer comprises at least one of polyacrylamide, poly(ethylene oxide), or poly(vinylpyrrolidone).

20. The composition of claim 1, wherein the polymeric adhesive comprises at least one of an acrylic polymer or styrene/butadiene rubber.

21. The composition of claim 1 packaged in a spray container.
